(19) United States
(12) Patent Application Publication
(10) Pub. No.: US 2021/0368255 A1
(43) Pub. Date: Nov. 25, 2021

(54) BONE CONDUCTION BLUETOOTH MONO EARSET

(71) Applicant: Dae Hoon LEE, Goyang, Gyeonggi-do (KR)

(72) Inventor: Dae Hoon LEE, Goyang, Gyeonggi-do (KR)

(21) Appl. No.: 16/485,448

(22) PCT Filed: May 29, 2019
(86) PCT No.: PCT/KR2019/006408

§ 371 Date: Aug. 13, 2019

(51) Int. Cl. H04R 1/10; H04R 3/02

(52) U.S. Cl. CPC H04R 1/1041; H04R 1/105; H04R 2420/07; H04R 1/1025; H04R 2460/13; H04R 3/02

(57) ABSTRACT

A bone conduction Bluetooth mono ear-set includes an earring part 110 configured to be putted on one ear of a wearer; a main body part 130 having an inner space for installation, the earring part 110 being vertically installed on an outer rim and a semicircle-shaped concave groove for installation 132 being formed on an outer end contacted with the wearer; a bone conduction speaker and microphone module 140 which is installed by being partially inserted into the groove for installation 132; and a controlling part 150 which is mounted inside the main body part 130 and electrically connected with the bone conduction speaker and microphone module 140, so as to control the operation of the bone conduction speaker and microphone module 140 according to the wearer's control.

### TECHNICAL FIELD

The present invention relates to a bone conduction Bluetooth mono ear-set, and more particularly a bone conduction Bluetooth mono ear-set having a compact design and an improved convenience

### BACKGROUND

Generally, there are two ways in which a person can hear a sound: air conduction and bone conduction. The air conduction is a method in which the vibration of the sound is transmitted to the eardrum through air and the vibration of the eardrum is transmitted to the screw-shaped cochlea through the auditory ossicles, three bones located in the eardrum. The cochlea is filled with lymph fluid and the vibration of the lymph fluid is converted to an electric signal. Thus, as the electric signal is transmitted to the auditory nerve, the human brain can recognize the sound.

The bone conduction transmits the vibration of the sound to the screw-shaped cochlea directly through the skull without transmitting the vibration through the eardrum and the auditory ossicles. Thus, the sound can be transmitted through bone conduction even in the case that the eardrum and the auditory ossicles have an abnormality. The bone conduction can be realized using a bone conduction speaker.

The advantage of bone conduction speaker is that it does not affect a wearer's hearing even when used for a long time, and the wearer can listen to both sound through the air conduction and sound through the bone conduction, so that he can actively cope with sudden and dangerous situations.

In addition, the bone conduction speaker enables more accurate communication in a noisy environment as compared to a general speaker, and is widely used in applications such as communication devices for a hearing-impaired person, multimedia home appliances, internet phones, Bluetooth headsets for a mobile phone and military applications.

Meanwhile, in a conventional hands-free device or ear-set, since a microphone that receives a user's call voice is exposed to the outside and located at a position away from the mouth of the user, the microphone may receive ambient noises other than the call voice. Thus, there are problems that the communication quality is lowered and the microphone exposed to the outside is easy to be contaminated.

Therefore, there is an attempt to develop and commercialize a hands-free device or ear-set incorporating an In Ear MIC which receives a user's call voice transmitted through his eardrum by inserting a microphone into the ear canal of the user.

However, although the bone conduction has the advantages as described above, since an In Ear MIC is located adjacent a bone conduction speaker, the In Ear MIC is interfered by the vibration of the bone conduction speaker. Thus, it is easy to generate a howling when using the In Ear MIC. In addition, when a bone conduction speaker is applied to an earphone or ear-set, low-frequency sounds are reinforced by constructive interference in a space within the ear canal, but middle- to high-frequency sounds are attenuated as the vibration is transmitted to bone and skin tissue. As a result, there was a limitation in realizing a high quality sound.

### DETAILED DESCRIPTION OF THE INVENTION

To solve the aforementioned problems in the prior art, in an aspect, the present invention provides a bone conduction Bluetooth mono ear-set which converts the vibrations of a wearer's facial skin as the wearer speaks to audible electric signals and transmits these signals to a user's terminal for receiving that is connected wirelessly to the ear-set.

In another aspect, the present invention provides a bone conduction Bluetooth mono ear-set which has a bone conduction speaker and a skin conduction microphone mounted in a module form.

To the end, according to the present invention, a bone conduction Bluetooth mono ear-set comprises an earring part 110 configured to be putted on one ear of a wearer; a main body part 130 having an inner space for installation, the earring part 110 being vertically installed on an outer rim and a semicircle-shaped concave groove for installation 132 being formed on an outer end contacted with the wearer; a bone conduction speaker and microphone module 140 which is installed by being partially inserted into the groove for installation 132, so as to transmit acoustic signals received from outside to the wearer in the manner of bone conduction or to process vibrations of facial skin generated as the wearer speaks to electric signals and transmit the processed signals; and a controlling part 150 which is mounted inside the main body part 130 and electrically connected with the bone conduction speaker and microphone module 140, so as to control the operation of the bone conduction speaker and microphone module 140 according to the wearer's control.

In addition, according to the present invention, the bone conduction Bluetooth mono ear-set further comprises a battery module 120 which is removably coupled to an upper end of the earring part 110 of the ear-set, to supply electrical power charged in advance, and wherein when the earring part 110 is coupled to the battery module 120, preferably an electrical connection port 118 formed in an end of the earring part 110 is removably connected to an electrical plug formed in an end of the battery module 120 which corresponds to the earring port 110.

According to the present invention, the main body part 130 comprises a main body case 131 comprising a first case 131a and a second case 131b, wherein the first case 131a has an inner space for installation with one side opened, a first installation hole 134a being through-formed in an outer rim at an upper end, and a second installation hole 134b being through-formed in an outer center of the space for installation; and the second case 131b is configured to cover the opened one side of the first case 131a and has a semicircle-shaped concave groove for installation 132 formed in an outer end, a mounting protrusion 133 formed on a bottom surface of the groove for installation 132 at a desired height, and a protrusion 135 formed in an outer center at a desired length.

According to the present invention, a coupling rod 112 is formed protrusively from a lower end of the earring part 110 by a desired length towards the outside. Preferably, the coupling rod 112 is inserted into the first installation hole 134a through-formed in an outer rim at an upper end of the main body case 131. Then, it can fix the earring part 110 within the main body part 130 using a coupling member.

According to the present invention, the bone conduction speaker and microphone module 140 comprises a case 141 which is installed by being inserted into the second installation hole 134b of the case 131 of the main body part 130 and fastened by being inserted into the mounting protrusion 133 formed on the bottom surface of the groove for installation 132, and has concave first and second grooves for installation 142 and 143 formed inside the case; a skin conduction microphone 144 inserted and installed into the first groove for installation 142 of the case 141; a bone conduction transducer 145 inserted and installed into the second groove for installation 143 of the case 141; and a case cover 148 for covering an opened side of the case 141.

The bone conduction Bluetooth mono ear-set according to the present invention has the following effects.

Firstly, the bone conduction Bluetooth mono ear-set according to the present invention can convert the vibrations of a wearer's facial skin as the wearer speaks are converted to audible electric signals and transmit these signals to a user's terminal for receiving that is connected wirelessly to the ear-set. Accordingly, a howling is reduced and attenuation of middle- to high-frequency sounds is prevented as compared to using a bone conduction microphone, thereby realizing a high quality sound quality

Secondly, the bone conduction Bluetooth mono ear-set according to the present invention can have a bone conduction speaker and a skin conduction microphone mounted in a module form. Accordingly, a wearer's discomfort can be minimized even when the ear-set is used for a long time or used with a gas mask.

### BRIEF DESCRIPTION OF THE DRAWINGS

FIG. 1 is a perspective view showing an overall appearance of a bone conduction Bluetooth mono ear-set according to a preferred embodiment of the present invention.

FIG. 2 is a perspective view showing the interior of a bone conduction Bluetooth mono ear-set according to a preferred embodiment of the present invention.

FIG. 3 is an exploded perspective view of a bone conduction Bluetooth mono ear-set according to a preferred embodiment of the present invention.

FIG. 4 is a view depicting the procedure of assembling a battery module of a bone conduction Bluetooth mono ear-set according to a preferred embodiment of the present invention.

FIG. 5 is a view depicting a wearing state of a bone conduction Bluetooth mono ear-set according to a preferred embodiment of the present invention.

FIG. 6 is a block diagram of a controlling part of a bone conduction Bluetooth mono ear-set according to a preferred embodiment of the present invention.

FIGS. 7 and 8 are graphs showing a result of extracting noises included in wearer's voice signals and performing LMS processing when the wearer speaks using a bone conduction Bluetooth mono ear-set according to a preferred embodiment of the present invention.

### PREFERRED EMBODIMENTS OF THE INVENTION

Hereinafter, the configuration and operation of a bone conduction Bluetooth mono ear-set according to a preferred embodiment of the present invention will be described with reference to the accompanying drawings.

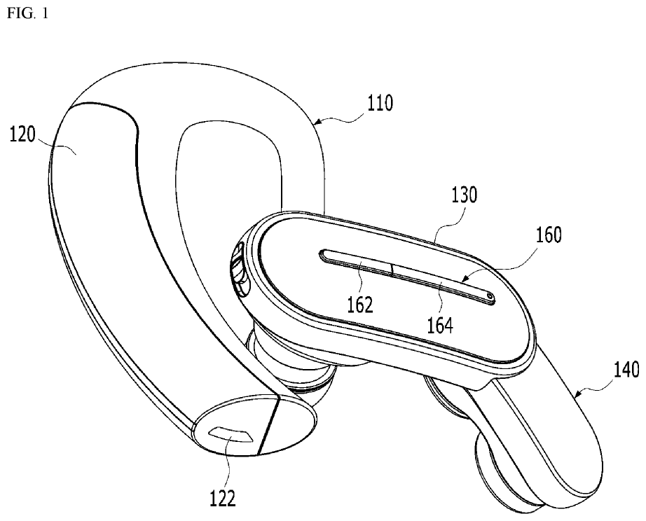

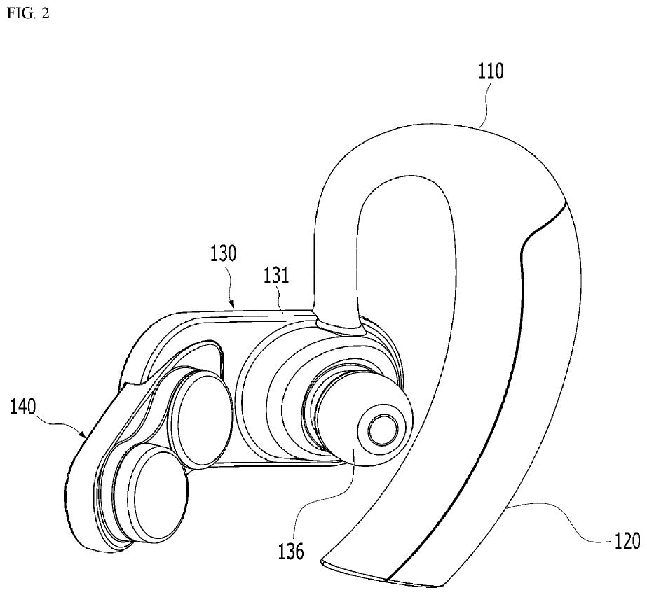

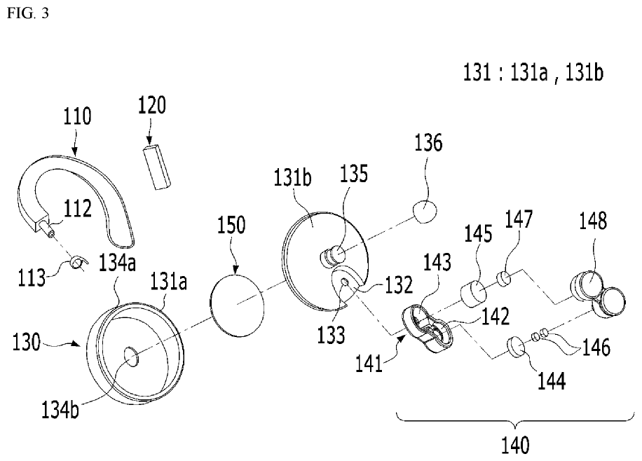

FIG. 1 is a perspective view showing an overall appearance of a bone conduction Bluetooth mono ear-set according to a preferable example of the present invention; FIG. 2 is a perspective view showing the interior of a bone conduction Bluetooth mono ear-set according to a preferable example of the present invention; and FIG. 3 is an exploded perspective view of a bone conduction Bluetooth mono ear-set according to a preferable example of the present invention.

Referring to FIGS. 1 to 3, a bone conduction Bluetooth mono ear-set consists of an earring part 110 configured to be putted on one ear of a wearer; a battery module 120 which is removably coupled to an upper end of the earring part 110, to supply electrical power charged in advance; a main body part 130 having an inner space for installation, the earring part 110 being vertically installed on an outer rim and a semicircle-shaped concave groove for installation 132 being formed on an outer end contacted with the wearer; a bone conduction speaker and microphone module 140 which is installed by being partially inserted into the groove for installation 132, so as to transmit acoustic (audio) signals received from outside to the wearer in the manner of bone conduction or to process vibrations of facial skin generated as the wearer speaks to electric signals and transmit the processed signals; and a controlling part 150 which is mounted inside the main body part 130 and electrically connected with the bone conduction speaker and microphone module 140, so as to control the operation of the bone conduction speaker and microphone module 140 according to the wearer's control.

Preferably, an electric wire (not shown) is installed between the battery module 120 and the controlling part 150 within the main body part 130 in the interior of the earring part 110, and a fitting rib (not shown) is formed in a bottom surface within the earring part 110 to fix the wire after installation.

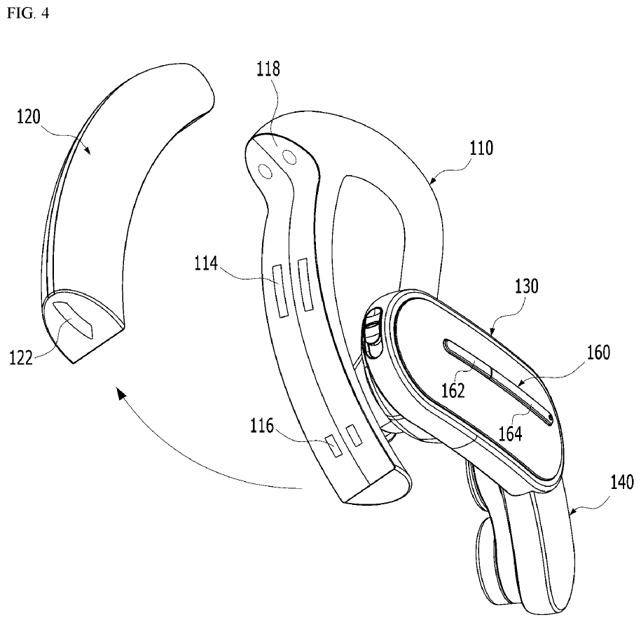

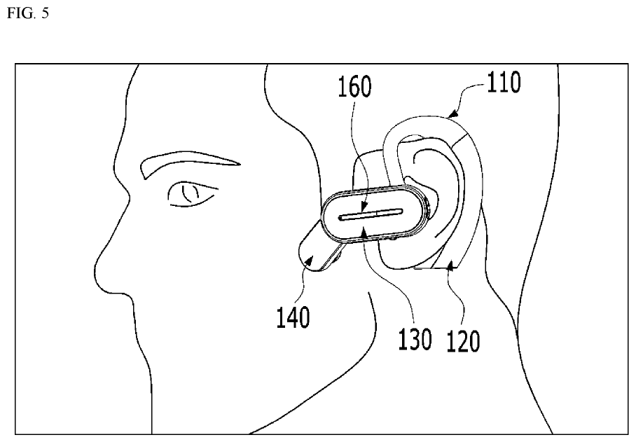

In addition, the upper end of the earring part 110 is cut-formed as L-shaped form, as shown in FIG. 4. The bottom surface of the battery module 120 having a chargeable battery therein can be removably coupled to the upper end of the earring part 110 cut-formed.

The main body part 130, as shown in FIG. 3, consists of a main body case 131 comprising a first case 131a and a second case 131b, wherein the first case 131a has an inner space for installation with one side opened, a first installation hole 134a being through-formed in an outer rim at an upper end, and a second installation hole 134b being through-formed in an outer center of the space for installation; and the second case 131b is configured to cover the opened one side of the first case 131a and has a semicircle-shaped concave groove for installation 132 formed in an outer end, a mounting protrusion 133 formed on a bottom surface of the groove for installation 132 at a desired height, and a protrusion 135 formed in an outer center at a desired length; a rubber ear plug 136 which is mounted in the protrusion 135 to be inserted into the wearer's ear hole at a desired length to minimize ambient noises; and an operating part 160 which is protrusively installed in the second installation hole 134b of the main body case 131 to connect with the controlling part 150 electrically and has a power on/off switch 162 and a volume control switch 164.

According to the present invention, as shown in FIG. 3, a coupling rod 112 is formed protrusively from a lower end of the earring part 110 by a desired length towards the outside. Preferably, the coupling rod 112 is inserted into the first installation hole 134a through-formed in an outer rim at an upper end of the main body case 131. Then, it can fix the earring part 110 within the main body part 130 using a coupling member such as a fixing spring 113 or a nut.

The bone conduction speaker and microphone module 140 consists of a case 141 which is installed by being inserted into the second installation hole 134b of the first case 131a and fastened by being inserted into the mounting protrusion 133, and has concave first and second grooves for installation 142 and 143 formed inside the case; a skin conduction microphone 144 inserted and installed into the first groove for installation 142 of the case 141; a first acoustic cushion 146 installed on the top of the skin conduction microphone 144; a bone conduction transducer 145 inserted and installed into the second groove for installation 143 of the case 141; a second acoustic cushion 147 installed on the top of the bone conduction transducer 145; and a case cover 148 for covering an opened side of the case 141.

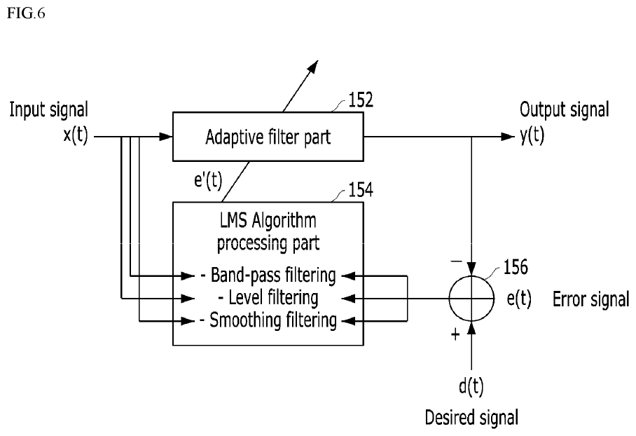

As shown in FIG. 6, the controlling part 150 consists of an adaptive filter part 152, LMS algorithm processing part 154, and an error signal detecting part 156, wherein the adaptive filter part 152 determines the current output value by estimating an Optimum Wiener Filter's coefficient at predetermined times with respect to a sample of audio signals inputted through the skin conduction microphone 144; the LMS algorithm processing part 154 performs band-pass filtering of periodic noises included in input signals inputted through the skin conduction microphone 144, level filtering of non-periodic noises included in the input signals and smoothing filtering of impulse sounds or instant noises included in the input signals, respectively, followed by outputting to the adaptive filter part 152; and the error signal detecting part 156 compares an output signal from the adaptive filter part 152 with a preset reference signal to extract an error signal and performs feedback of the error signal to the LMS algorithm processing part 154. According to a preferred embodiment, the adaptive filter part 152 estimates an Optimum Wiener Filter's coefficient every time a sample is inputted with respect to signals including non-stationary signals of which the statistical property varies over time using either one of the Adjacent Averaging method and the Savitzky-Golay method.

Hereinafter, the operation of a bone conduction Bluetooth mono ear-set according to the preferred embodiment of the present invention will be described with reference to the accompanying drawings.

(1) Change of Battery Module

When the earring part 110 is coupled to the battery module 120, an electrical connection port 118 formed in an end of the earring part 110 is removably connected to an electrical plug formed in an end of the battery module 120 which corresponds to the earring port 110. Simultaneously, first and second coupling holes 114 and 116 are removably coupled to first and second coupling protrusions formed on a bottom surface of the battery module 120.

In contrast, when the battery module 120 is separated from the earring part 110 for charging and so on, the electrical connection port 118 formed in an end of the earring part 110 is separated from the electrical plug formed in an end of the battery module 120 which corresponds to the earring port 110. Simultaneously, the first and second coupling holes 114 and 116 are separated from the first and second coupling protrusions formed on a bottom surface of the battery module 120.

(2) Operation of Receiving a Voice Signal from the Outside and Transmitting a Wearer's Voice

The controlling part 150 controls sound signals transmitted from an external device such as a smart phone to be converted into electric signals and transmits the converted signals to the auditory nerve, ultimately to supply these signals to the bone conduction transducer 145. In addition, the controlling part 150 controls the vibration of the wearer's facial skin received from the skin conduction microphone 144 to be converted into audible electric signals and outputs the converted signals to the wearer's terminal for receiving using a wireless network such as Bluetooth.

When the wearer speaks, the skin conduction microphone 144 transmits the received voice signals to the controlling part 150. Then, the controlling part 150 performs a preset filtering. Such operation will be further described with reference to FIGS. 6 to 8.

The adaptive filter part 152 of the controlling part 150 determines the current output value by estimating an Optimum Wiener Filter's coefficient from voice signals inputted through the skin conduction microphone 144.

The LMS algorithm processing part 154 performs band-pass filtering of periodic noises included in voice signals inputted through the skin conduction microphone 144, level filtering of non-periodic noises included in the voice signals and smoothing filtering of impulse sounds or instant noises included in the voice signals, followed by outputting to the adaptive filter part 152.

The error signal detecting part 156 compares an output signal outputted from the adaptive filter part 152 with a preset desired signal to perform feedback of a detected error signal to the LMS algorithm processing part 154 when an error exceeds a preset range.

Thus, the controlling part 150 can extract noises from the wearer's voice signals and minimize the extracted noises through adaptive filter part 152, the LMS algorithm processing part 154, and the error signal detecting part 156, thereby restoring stable voice data from the original voice signals including noises.

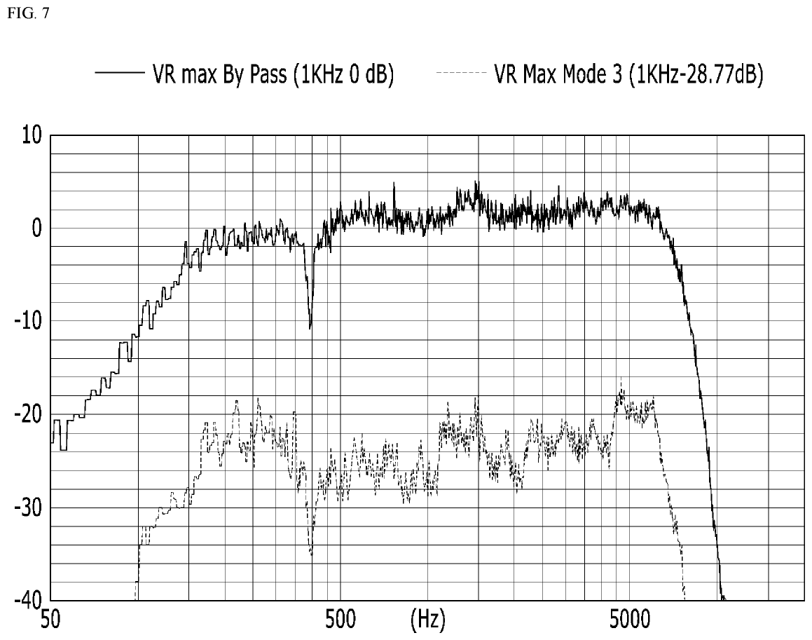

The upper graph of FIG. 7 shows voice signals including noises generated when a wearer speaks, and the lower graph shows a result of extracting effectively various noises included in voice signals generated when the wearer speaks.

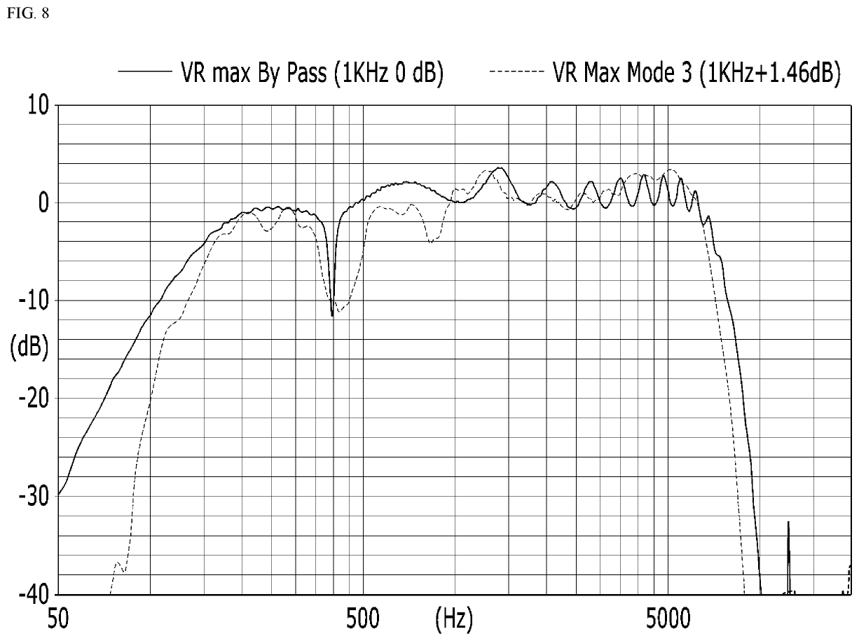

The upper graph of FIG. 8 shows distorted voice signals processed using an usual filtering method, and the lower graph shows non-distorted voice signals restored from the original voice signals in which noises are removed through LMS filtering by the controlling part of the bone conduction ear-set according to the present invention.

The present invention has been described herein with reference to the preferred embodiments and specific examples as well as the drawings. However, it should be understood that they are merely provided to aid the overall comprehension and implementation of the present invention, but the present invention is not limited to these embodiments and examples. Various modifications and variations are made to the present invention by those skilled in the art to which the present invention pertains based on such description.

Accordingly, the present invention should not be construed as being limited to the embodiments and examples described, and the present invention encompasses the following claims, as well as all equivalents thereof

What is claimed is:

1. A bone conduction Bluetooth mono ear-set comprising:
an earring part 110 configured to be putted on one ear of a wearer;
a main body part 130 having an inner space for installation, the earring part 110 being vertically installed on an outer rim and a semicircle-shaped concave groove for installation 132 being formed on an outer end contacted with the wearer;
a bone conduction speaker and microphone module 140 which is installed by being partially inserted into the groove for installation 132, so as to transmit acoustic signals received from outside to the wearer in the manner of bone conduction or to process vibrations of facial skin generated as the wearer speaks to electric signals and transmit the processed signals; and
a controlling part 150 which is mounted inside the main body part 130 and electrically connected with the bone conduction speaker and microphone module 140, so as to control the operation of the bone conduction speaker and microphone module 140 according to the wearer's control.

2. The bone conduction Bluetooth mono ear-set of claim 1, further comprising a battery module 120 which is removably coupled to an upper end of the earring part 110, to supply electrical power charged in advance, and wherein when the earring part 110 is coupled to the battery module 120, an electrical connection port 118 formed in an end of the earring part 110 is removably connected to an electrical plug formed in an end of the battery module 120 which corresponds to the earring port 110.

3. The bone conduction Bluetooth mono ear-set of claim 1 wherein the main body part 130 comprises a main body case 131 comprising a first case 131a and a second case 131b, wherein the first case 131a has an inner space for installation with one side opened, a first installation hole 134a being through-formed in an outer rim at an upper end, and a second installation hole 134b being through-formed in an outer center of the space for installation; and the second case 131b is configured to cover the opened one side of the first case 131a and has a semicircle-shaped concave groove for installation 132 formed in an outer end, a mounting protrusion 133 formed on a bottom surface of the groove for installation 132 at a desired height, and a protrusion 135 formed in an outer center at a desired length.

4. The bone conduction Bluetooth mono ear-set of claim 1, wherein the bone conduction speaker and microphone module 140 comprises a case 141 which is installed by being inserted into the second installation hole 134b of the case 131 of the main body part 130 and fastened by being inserted into the mounting protrusion 133 formed on the bottom surface of the groove for installation 132, and has concave first and second grooves for installation 142 and 143 formed inside the case; a skin conduction microphone 144 inserted and installed into the first groove for installation 142 of the case 141; a bone conduction transducer 145 inserted and installed into the second groove for installation 143 of the case 141; and a case cover 148 for covering an opened side of the case 141.

5. The bone conduction Bluetooth mono ear-set of claim 1, wherein the controlling part 150 comprises an adaptive filter part 152, LMS algorithm processing part 154, and an error signal detecting part 156, wherein the adaptive filter part 152 determines the current output value by estimating an Optimum Wiener Filter's coefficient at predetermined times with respect to a sample of audio signals inputted through the bone conduction speaker and microphone module 140; the LMS algorithm processing part 154 performs band-pass filtering of periodic noises included in input signals inputted through the bone conduction speaker and microphone module 140, level filtering of non-periodic noises included in the input signals and smoothing filtering of impulse sounds or instant noises included in the input signals, respectively, followed by outputting to the adaptive filter part 152; and the error signal detecting part 156 compares an output signal from the adaptive filter part 152 with a preset desired signal to extract an error signal and performs feedback of the error signal to the LMS algorithm processing part 154.
